(19) United States
(12) Patent Application Publication
(10) Pub. No.: US 2026/0009889 A1
(43) Pub. Date: Jan. 8, 2026

(54) APPARATUS FOR DETECTING DIFFUSE REFLECTION NOISE OF ULTRASONIC SENSOR AND METHOD FOR THE SAME

(71) Applicant: HYUNDAI MOBIS CO., LTD., Seoul (KR)

(72) Inventor: Kang Hee Kim, Yongin-si (KR)

(73) Assignee: HYUNDAI MOBIS CO., LTD., Seoul (KR)

(21) Appl. No.: 19/231,363

(22) Filed: Jun. 6, 2025

(30) Foreign Application Priority Data
Jul. 8, 2024 (KR) 10-2024-0089562

(51) Int. Cl. G01S 7/52; G01S 15/931

(52) U.S. Cl. CPC G01S 7/52001; G01S 15/931; G01S 2015/932; G01S 2015/938

(57) ABSTRACT

An apparatus for detecting diffuse reflection noise with respect to ultrasonic sensor values is disclosed. The apparatus includes a plurality of ultrasonic sensors; and a processor including a diffuse reflection noise detector for detecting diffuse reflection noise in sensor values obtained from the ultrasonic sensors. The diffuse reflection noise detector is configured to detect single-sensor-based diffuse reflection noise in obtained sensor data, and is configured to detect multi-sensor-based diffuse reflection noise when the single-sensor-based diffuse reflection noise is not detected.

This application claims the benefit of Korean Patent Application No. 10-2024-0089562, filed on Jul. 8, 2024, which is hereby incorporated by reference as if fully set forth herein.

### BACKGROUND OF THE DISCLOSURE

### Field of the Disclosure

The embodiments of the present disclosure relate to an apparatus and method for detecting diffuse reflection in data of an ultrasonic sensor, and more particularly to an apparatus and method for detecting diffuse reflection noise of ultrasonic sensor data used to prevent rear collision or rear-lateral collision when a vehicle is parked.

### Discussion of the Related Art

Ultrasonic sensors, which are mounted on front and rear bumpers of a vehicle or other ultrasonic sensors mounted on a vehicle body, are important components of a parking assistance system (PAS) or rear parking sensors. Ultrasonic sensors may detect obstacles located at a rear side or a lateral side of the vehicle, and may help a driver avoid collisions when the driver is parking the vehicle.

The ultrasonic sensor periodically transmits high-frequency sound waves (ultrasonic waves). When the transmitted ultrasonic signal collides with (hits) an obstacle, the ultrasonic sensor receives a signal reflected from the obstacle. Direct waves may refer to signals obtained when the corresponding ultrasonic sensor transmits signals and directly receives signals reflected from the obstacle. Indirect waves may refer to signals obtained when the corresponding ultrasonic sensor transmits signals and another ultrasonic sensor receives the signals reflected from the obstacle. If there are two ultrasonic sensors on both sides of the ultrasonic sensor, the ultrasonic sensor can obtain one direct wave and two indirect waves. The ultrasonic sensor may estimate the position of the reflection object (i.e., the obstacle) based on two intersections of the one direct wave and the two indirect waves. The intersection of the direct wave and the indirect waves may refer to, rather than the intersection of the actual signals, the intersection of a circle having a radius that is half a distance obtained based on a time of flight (ToF) of the direct wave and an ellipse formed by a set (aggregate) of points corresponding to distances from two focal points (two foci). In the ellipse, the positions of two ultrasonic sensors (i.e., a first sensor transmitting ultrasonic waves and a second sensor receiving the ultrasonic waves) are set to two focal points, and the distances from the two focal points are obtained based on a time of flight (TOF) of indirect waves. In the present specification, “intersection of direct wave and indirect waves” is simply referred to as “intersection”.

The TOF value (hereinafter referred to as ultrasonic sensor data) obtained by the ultrasonic sensor is used to estimate the position of an obstacle, so that the accuracy or reliability of the data must be guaranteed. If there is noise in the sensor data, the position of the obstacle based on the sensor data is likely to be incorrect.

The present disclosure proposes a method for detecting noise included in ultrasonic sensor data.

### SUMMARY OF THE DISCLOSURE

An object of the present disclosure is to provide an apparatus and method for detecting diffuse reflection noise in ultrasonic sensor data. Technical subjects to be solved by the present disclosure are not limited to the above-mentioned technical solutions, and it should be noted that other technical subjects not described above can be understood by those skilled in the art from the description of the present disclosure below.

In accordance with an embodiment of the present disclosure, an apparatus for detecting diffuse reflection noise with respect to ultrasonic sensor values may include: a plurality of ultrasonic sensors; and a processor including a diffuse reflection noise detector configured to detect diffuse reflection noise in sensor values obtained from the ultrasonic sensors. The diffuse reflection noise detector may attempt to detect single-sensor-based diffuse reflection noise in obtained sensor data; and may attempt to detect multi-sensor-based diffuse reflection noise when the single-sensor-based diffuse reflection noise is not detected. In accordance with another embodiment of the present disclosure, a method for detecting diffuse reflection noise with respect to ultrasonic sensor values by a diffuse reflection noise device that includes a plurality of ultrasonic sensors and a processor including a diffuse reflection noise detector configured to detect diffuse reflection noise in sensor values obtained from the ultrasonic sensors, the method may include: attempting to detect single-sensor-based diffuse reflection noise in obtained sensor data; and attempting to detect multi-sensor-based diffuse reflection noise when the single-sensor-based diffuse reflection noise is not detected.

It is to be understood that both the foregoing general description and the following detailed description of the present disclosure are exemplary and explanatory and are intended to provide further explanation of the disclosure as claimed.

### BRIEF DESCRIPTION OF THE DRAWINGS

The accompanying drawings, which are included to provide a further understanding of the disclosure and are incorporated in and constitute a part of this application, illustrate embodiment(s) of the disclosure and together with the description serve to explain the principle of the disclosure.

FIG. 1 is an overall block diagram illustrating an autonomous vehicle to which an autonomous driving apparatus can be applied.

FIG. 2 is a schematic diagram illustrating an example vehicle to which an autonomous driving apparatus is applied.

FIG. 3 is a diagram illustrating an example of diffuse reflection noise according to the embodiments of the present disclosure.

FIG. 4 is a diagram illustrating the principle of detecting diffuse reflection noise according to the embodiments of the present disclosure.

FIG. 5 is a diagram illustrating an example case in which diffuse reflection noise detection is required compared to another case (i.e., a normal case) in which diffuse reflection noise detection is not required.

FIG. 6 is a diagram illustrating an example case in which diffuse reflection noise detection is required compared to another case (i.e., a normal case) in which diffuse reflection noise detection is not required.

FIG. 7 is a diagram illustrating an example case in which diffuse reflection noise detection is required compared to another case (i.e., a normal case) in which diffuse reflection noise detection is not required.

FIG. 8 is a flowchart illustrating a method for detecting diffuse reflection noise according to the embodiments of the present disclosure.

FIG. 9 is a flowchart illustrating a method for detecting diffuse reflection noise according to the embodiments of the present disclosure.

FIG. 10 is a flowchart illustrating a method for detecting diffuse reflection noise according to the embodiments of the present disclosure.

FIG. 11 is a block diagram illustrating an apparatus for detecting diffuse reflection noise in sensor data according to the embodiments of the present disclosure.

### DETAILED DESCRIPTION OF THE DISCLOSURE

Hereinafter, embodiments of the present disclosure will be described in detail with reference to the accompanying drawings so that the present disclosure may be easily realized by those skilled in the art. However, the present disclosure may be achieved in various different forms and is not limited to the embodiments described herein. In the drawings, parts that are not related to a description of the present disclosure are omitted to clearly explain the present disclosure and similar reference numbers will be used throughout this specification to refer to similar parts.

In the specification, when a part “includes” an element, it means that the part may further include another element rather than excluding another element unless otherwise mentioned.

In addition, in the specification, “occupant”, “passenger”, “driver”, “user”, etc. are mentioned for description of the present disclosure, and may be used interchangeably therewith.

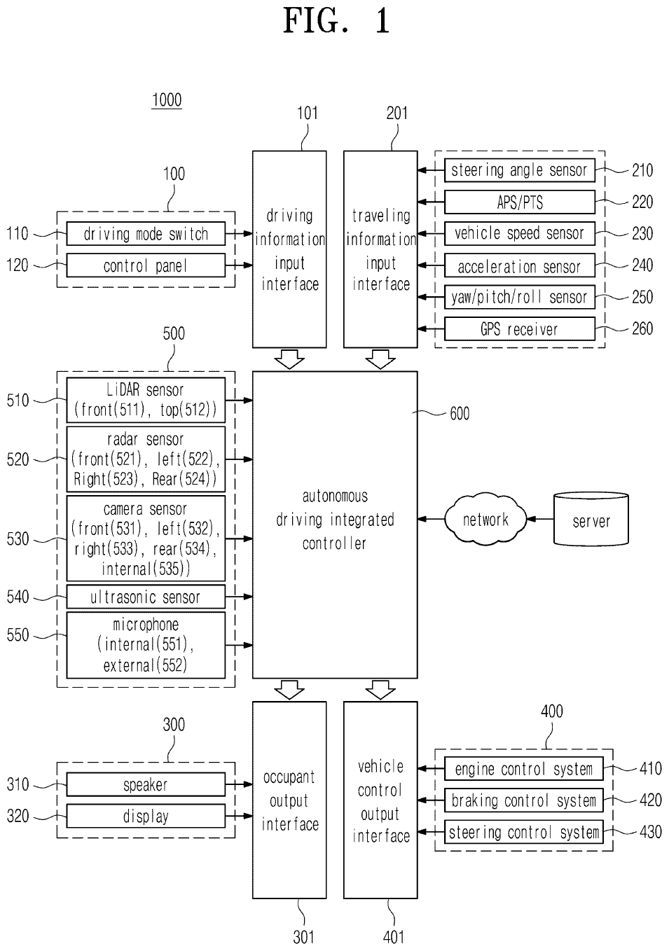

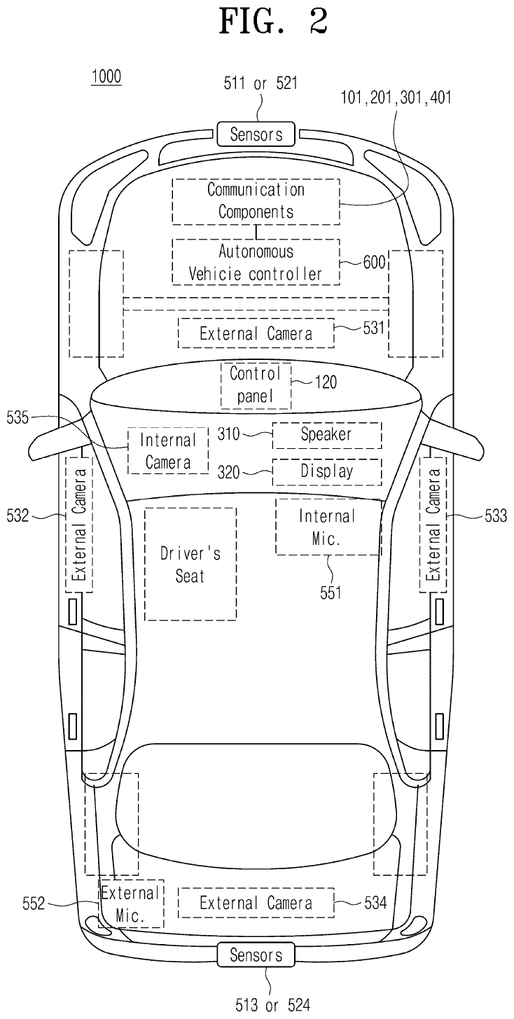

FIG. 1 is an overall block diagram of an autonomous driving control system to which an autonomous driving apparatus according to any one of embodiments of the present disclosure is applicable. FIG. 2 is a diagram illustrating an example in which an autonomous driving apparatus according to any one of embodiments of the present disclosure is applied to a vehicle.

First, a structure and function of an autonomous driving control system (e.g., an autonomous driving vehicle) to which an autonomous driving apparatus according to the present embodiments is applicable will be described with reference to FIGS. 1 and 2.

As illustrated in FIG. 1, an autonomous driving vehicle 1000 may be implemented based on an autonomous driving integrated controller 600 that transmits and receives data necessary for autonomous driving control of a vehicle through a driving information input interface 101, a traveling information input interface 201, an occupant output interface 301, and a vehicle control output interface 401. However, the autonomous driving integrated controller 600 may also be referred to herein as a controller, a processor, or, simply, a controller.

The autonomous driving integrated controller 600 may obtain, through the driving information input interface 101, driving information based on manipulation of an occupant for a user input unit 100 in an autonomous driving mode or manual driving mode of a vehicle. As illustrated in FIG. 1, the user input unit 100 may include a driving mode switch 110 and a control panel 120 (e.g., a navigation terminal mounted on the vehicle or a smartphone or tablet computer owned by the occupant). Accordingly, driving information may include driving mode information and navigation information of a vehicle.

For example, a driving mode (i.e., an autonomous driving mode/manual driving mode or a sports mode/eco mode/safety mode/normal mode) of the vehicle determined by manipulation of the occupant for the driving mode switch 110 may be transmitted to the autonomous driving integrated controller 600 through the driving information input interface 101 as the driving information.

Furthermore, navigation information, such as the destination of the occupant input through the control panel 120 and a path up to the destination (e.g., the shortest path or preference path, selected by the occupant, among candidate paths up to the destination), may be transmitted to the autonomous driving integrated controller 600 through the driving information input interface 101 as the driving information.

The control panel 120 may be implemented as a touchscreen panel that provides a user interface (UI) through which the occupant inputs or modifies information for autonomous driving control of the vehicle. In this case, the driving mode switch 110 may be implemented as touch buttons on the control panel 120.

In addition, the autonomous driving integrated controller 600 may obtain traveling information indicative of a driving state of the vehicle through the traveling information input interface 201. The traveling information may include a steering angle formed when the occupant manipulates a steering wheel, an accelerator pedal stroke or brake pedal stroke formed when the occupant depresses an accelerator pedal or brake pedal, and various types of information indicative of driving states and behaviors of the vehicle, such as a vehicle speed, acceleration, a yaw, a pitch, and a roll formed in the vehicle. The traveling information may be detected by a traveling information detection unit 200, including a steering angle sensor 210, an accelerator position sensor (APS)/pedal travel sensor (PTS) 220, a vehicle speed sensor 230, an acceleration sensor 240, and a yaw/pitch/roll sensor 250, as illustrated in FIG. 1.

Furthermore, the traveling information of the vehicle may include location information of the vehicle. The location information of the vehicle may be obtained through a global positioning system (GPS) receiver 260 applied to the vehicle. Such traveling information may be transmitted to the autonomous driving integrated controller 600 through the traveling information input interface 201 and may be used to control the driving of the vehicle in the autonomous driving mode or manual driving mode of the vehicle.

The autonomous driving integrated controller 600 may transmit driving state information provided to the occupant to an output unit 300 through the occupant output interface 301 in the autonomous driving mode or manual driving mode of the vehicle. That is, the autonomous driving integrated controller 600 transmits the driving state information of the vehicle to the output unit 300 so that the occupant may check the autonomous driving state or manual driving state of the vehicle based on the driving state information output through the output unit 300. The driving state information may include various types of information indicative of driving states of the vehicle, such as a current driving mode, transmission range, and speed of the vehicle.

If it is determined that it is necessary to warn a driver in the autonomous driving mode or manual driving mode of the vehicle along with the above driving state information, the autonomous driving integrated controller 600 transmits warning information to the output unit 300 through the occupant output interface 301 so that the output unit 300 may output a warning to the driver. In order to output such driving state information and warning information acoustically and visually, the output unit 300 may include a speaker 310 and a display 320 as illustrated in FIG. 1. In this case, the display 320 may be implemented as the same device as the control panel 120 or may be implemented as an independent device separated from the control panel 120.

Furthermore, the autonomous driving integrated controller 600 may transmit control information for driving control of the vehicle to a lower control system 400, applied to the vehicle, through the vehicle control output interface 401 in the autonomous driving mode or manual driving mode of the vehicle. As illustrated in FIG. 1, the lower control system 400 for driving control of the vehicle may include an engine control system 410, a braking control system 420, and a steering control system 430. The autonomous driving integrated controller 600 may transmit engine control information, braking control information, and steering control information, as the control information, to the respective lower control systems 410, 420, and 430 through the vehicle control output interface 401. Accordingly, the engine control system 410 may control the speed and acceleration of the vehicle by increasing or decreasing fuel supplied to an engine. The braking control system 420 may control the braking of the vehicle by controlling braking power of the vehicle. The steering control system 430 may control the steering of the vehicle through a steering device (e.g., motor driven power steering (MDPS) system) applied to the vehicle.

As described above, the autonomous driving integrated controller 600 according to the present embodiment may obtain the driving information based on manipulation of the driver and the traveling information indicative of the driving state of the vehicle through the driving information input interface 101 and the traveling information input interface 201, respectively, and transmit the driving state information and the warning information, generated based on an autonomous driving algorithm, to the output unit 300 through the occupant output interface 301. In addition, the autonomous driving integrated controller 600 may transmit the control information generated based on the autonomous driving algorithm to the lower control system 400 through the vehicle control output interface 401 so that driving control of the vehicle is performed.

In order to guarantee stable autonomous driving of the vehicle, it is necessary to continuously monitor the driving state of the vehicle by accurately measuring a driving environment of the vehicle and to control driving based on the measured driving environment. To this end, as illustrated in FIG. 1, the autonomous driving apparatus according to the present embodiment may include a sensor unit 500 for detecting a nearby object of the vehicle, such as a nearby vehicle, pedestrian, road, or fixed facility (e.g., a signal light, a signpost, a traffic sign, or a construction fence).

The sensor unit 500 may include one or more of a LiDAR sensor 510, a radar sensor 520, or a camera sensor 530, in order to detect a nearby object outside the vehicle, as illustrated in FIG. 1.

The LiDAR sensor 510 may transmit a laser signal to the periphery of the vehicle and detect a nearby object outside the vehicle by receiving a signal reflected and returning from a corresponding object. The LiDAR sensor 510 may detect a nearby object located within the ranges of a preset distance, a preset vertical field of view, and a preset horizontal field of view, which are predefined depending on specifications thereof. The LiDAR sensor 510 may include a front LiDAR sensor 511, a top LiDAR sensor 512, and a rear LiDAR sensor 513 installed at the front, top, and rear of the vehicle, respectively, but the installation location of each LiDAR sensor and the number of LiDAR sensors installed are not limited to a specific embodiment. A threshold for determining the validity of a laser signal reflected and returning from a corresponding object may be previously stored in a memory (not illustrated) of the autonomous driving integrated controller 600. The autonomous driving integrated controller 600 may determine a location (including a distance to a corresponding object), speed, and moving direction of the corresponding object using a method of measuring time taken for a laser signal, transmitted through the LiDAR sensor 510, to be reflected and returning from the corresponding object.

The radar sensor 520 may radiate electromagnetic waves around the vehicle and detect a nearby object outside the vehicle by receiving a signal reflected and returning from a corresponding object. The radar sensor 520 may detect a nearby object within the ranges of a preset distance, a preset vertical field of view, and a preset horizontal field of view, which are predefined depending on specifications thereof. The radar sensor 520 may include a front radar sensor 521, a left radar sensor 522, a right radar sensor 523, and a rear radar sensor 524 installed at the front, left, right, and rear of the vehicle, respectively, but the installation location of each radar sensor and the number of radar sensors installed are not limited to a specific embodiment. The autonomous driving integrated controller 600 may determine a location (including a distance to a corresponding object), speed, and moving direction of the corresponding object using a method of analyzing power of electromagnetic waves transmitted and received through the radar sensor 520.

The camera sensor 530 may detect a nearby object outside the vehicle by photographing the periphery of the vehicle and detect a nearby object within the ranges of a preset distance, a preset vertical field of view, and a preset horizontal field of view, which are predefined depending on specifications thereof.

The camera sensor 530 may include a front camera sensor 531, a left camera sensor 532, a right camera sensor 533, and a rear camera sensor 534 installed at the front, left, right, and rear of the vehicle, respectively, but the installation location of each camera sensor and the number of camera sensors installed are not limited to a specific embodiment. The autonomous driving integrated controller 600 may determine a location (including a distance to a corresponding object), speed, and moving direction of the corresponding object by applying predefined image processing to an image captured by the camera sensor 530.

In addition, an internal camera sensor 535 for capturing the inside of the vehicle may be mounted at a predetermined location (e.g., rear view mirror) within the vehicle. The autonomous driving integrated controller 600 may monitor a behavior and state of the occupant based on an image captured by the internal camera sensor 535 and output guidance or a warning to the occupant through the output unit 300.

As illustrated in FIG. 1, the sensor unit 500 may further include an ultrasonic sensor 540 in addition to the LiDAR sensor 510, the radar sensor 520, and the camera sensor 530 and further adopt various types of sensors for detecting a nearby object of the vehicle along with the sensors.

FIG. 2 illustrates an example in which, in order to aid in understanding the present embodiment, the front LiDAR sensor 511 or the front radar sensor 521 is installed at the front of the vehicle, the rear LiDAR sensor 513 or the rear radar sensor 524 is installed at the rear of the vehicle, and the front camera sensor 531, the left camera sensor 532, the right camera sensor 533, and the rear camera sensor 534 are installed at the front, left, right, and rear of the vehicle, respectively. However, as described above, the installation location of each sensor and the number of sensors installed are not limited to a specific embodiment.

Furthermore, in order to determine a state of the occupant within the vehicle, the sensor unit 500 may further include a bio sensor for detecting bio signals (e.g., heart rate, electrocardiogram, respiration, blood pressure, body temperature, electroencephalogram, photoplethysmography (or pulse wave), and blood sugar) of the occupant. The bio sensor may include a heart rate sensor, an electrocardiogram sensor, a respiration sensor, a blood pressure sensor, a body temperature sensor, an electroencephalogram sensor, a photoplethysmography sensor, and a blood sugar sensor.

Finally, the sensor unit 500 additionally includes a microphone 550 having an internal microphone 551 and an external microphone 552 used for different purposes.

The internal microphone 551 may be used, for example, to analyze the voice of the occupant in the autonomous driving vehicle 1000 based on Al or to immediately respond to a direct voice command of the occupant.

In contrast, the external microphone 552 may be used, for example, to appropriately respond to safe driving by analyzing various sounds generated from the outside of the autonomous driving vehicle 1000 using various analysis tools such as deep learning.

For reference, the symbols illustrated in FIG. 2 may perform the same or similar functions as those illustrated in FIG. 1. FIG. 2 illustrates in more detail a relative positional relationship of each component (based on the interior of the autonomous driving vehicle 1000) as compared with FIG. 1.

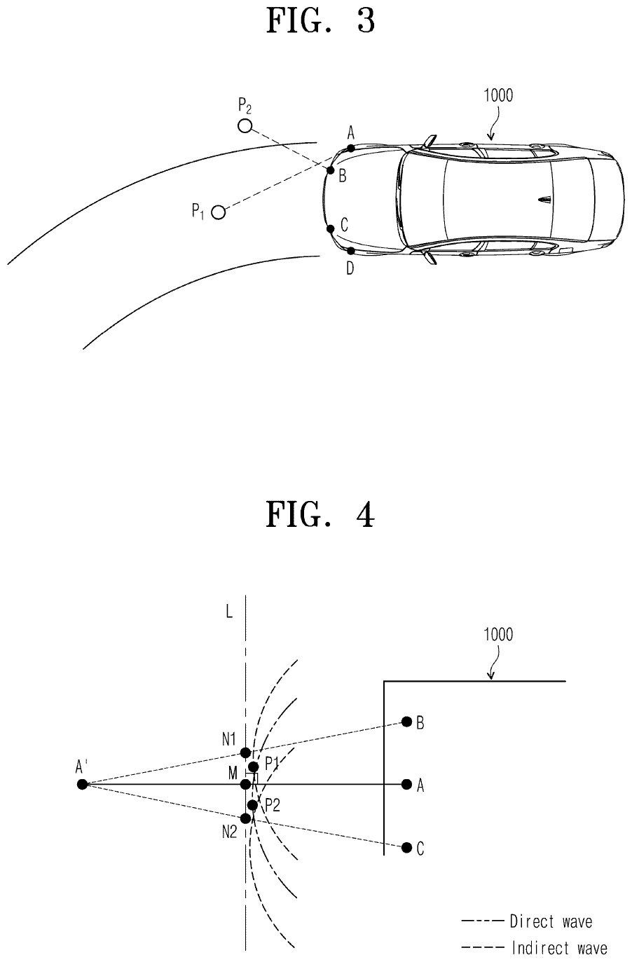

FIG. 3 is a diagram illustrating an example of diffuse reflection noise according to the embodiments of the present disclosure.

Referring to FIG. 3, a plurality of ultrasonic sensors (A, B, C, D) is provided on a rear bumper of the vehicle 1000. Although four ultrasonic sensors are illustrated in FIG. 3 for convenience of description, the number of ultrasonic sensors is not limited thereto.

Each ultrasonic sensor may receive reflected ultrasonic signals and calculate the TOF to estimate the position of an obstacle.

Noise present in data of the ultrasonic sensor (hereinafter referred to as ultrasonic sensor data) can be categorized as follows.

Static noise or dynamic noise: Example case in which the TOF values do not tend to update when reflected from the same object.

Diffuse reflection noise: Example case in which the positions of reflection objects (obstacles) according to the TOF values do not match each other.

Dynamic noise refers to noise of ultrasonic data that is estimated or determined when direct waves are not continuously reflected and updated from two objects (or reflection points) (P1, P2), but refers to noise in ultrasonic data estimated or determined when direct waves are reflected and updated from other objects.

Static noise refers to noise of ultrasonic data that is estimated or determined when the direct waves and indirect waves tend to be updated after being reflected by different objects.

As shown in FIG. 3, diffuse reflection noise is noise of ultrasonic data that is estimated or determined when the reflection points of two different ultrasonic sensors (A, B) are not probabilistically aligned. That the reflection points are not probabilistically matched means that a TOF value updated by the ultrasonic sensor is highly likely to be an object located closest to the ultrasonic sensor, but this means that the TOF value does not match or corresponds to relative positions between the ultrasonic sensors and the reflection points as in a low-probability case in which TOF signals of the ultrasonic sensors are reflected by a distant object with a low probability and then updated.

That is, if the dotted line between ‘P1’ and ‘A’ and the dotted line between ‘P2’ and ‘B’ in FIG. 3 represent the path of direct waves, it is reasonable for P2 to be updated at ultrasonic sensor ‘A’, and it is reasonable for P1 to be updated at ultrasonic sensor ‘B’. The above-described case in which validity is violated may be expressed as (probabilistic) mismatch or (probabilistic) non-match, and in such cases, it can be determined that the obtained sensor data contains diffuse reflection noise.

A method for detecting diffuse reflection noise will be described in more detail.

FIG. 4 is a diagram illustrating the principle of detecting diffuse reflection noise according to the embodiments of the present disclosure.

The ultrasonic sensor basically has a high probability of detecting the distance to the object at the closest point. At this time, it is assumed that the reflectivity of the object is the same on all side surfaces.

In other words, the method of using both the direct wave and the indirect wave has a high probability of detecting the shortest distance on the path from one ultrasonic sensor to another ultrasonic sensor.

Accordingly, as shown in FIG. 4, the reflection point of the direct wave is likely to be the point (M) on the surface (L) of the object when a line is drawn perpendicular to the object.

The reflection point of the indirect wave is the shortest distance from the ultrasonic sensor (A) to the ultrasonic sensors (B, C), so that the reflection points of indirect waves are likely to be N1 and N2, respectively.

Accordingly, in order to estimate the position of the reflection point (i.e., object or obstacle), if the TOF values of the direct and indirect waves or the distances corresponding to the TOF values are used, the intersection (P1) between the direct wave (detected by the ultrasonic sensor (A) according to the ultrasonic signal transmitted from the ultrasonic sensor A) and the indirect wave (detected by the ultrasonic sensor B), and the intersection (P2) between the direct wave (detected by the ultrasonic sensor A according to the ultrasonic signal transmitted from the ultrasonic sensor A) and the indirect wave (detected by the ultrasonic sensor C) may be obtained.

In this way, based on the ultrasonic signals from the ultrasonic sensor (A), the position of the intersection (or reflection point) (P1) obtained using the ultrasonic sensor (A) and the ultrasonic sensor (B) may be located between M and N1, and the position of the intersection (reflection point) (P2) obtained using the ultrasonic sensor (A) and the ultrasonic sensor (C) may be located between M and N2, which can be expressed as the relative positions of the intersections and the relative positions of the sensors being mutually aligned or consistent. This is because the relative positions of the reflection points (P1, P2) are arranged such that P1 is located above P2 and the ultrasonic sensor (B) is located above the ultrasonic sensor (C).

On the other hand, if the positions of P1 and P2 are estimated to be located between M and N2 and between M and N1, respectively, this means that the relative positions of the reflection points (P1, P2) are not mutually aligned with or are inconsistent with the relative positions of the ultrasonic sensors (A, B, C). In this way, if the relative positions of the reflection points obtained through the ultrasonic sensors do not match the relative positions of the ultrasonic sensors, it can be determined that diffuse reflection has occurred in the ultrasonic signal, and it can also be determined that there is diffuse reflection noise in the ultrasonic sensor data.

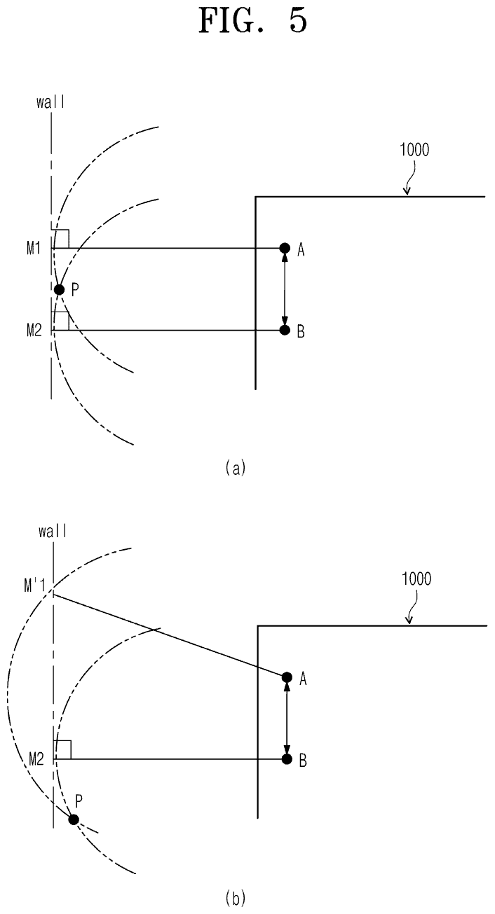

FIG. 5 is a diagram illustrating an example case in which diffuse reflection noise detection is required compared to another case (i.e., a normal case) in which diffuse reflection noise detection is not required.

FIG. 5(a) illustrates an example case in which no diffuse reflection noise occurs, and FIG. 5(b) illustrates an example case in which diffuse reflection noise occurs.

Dynamic noise and static noise are used for a method for determining noise of a single sensor. Dynamic noise may be used to determine the amount of change in the magnitude of the direct wave of a single sensor over time, and static noise may be used to determine the magnitude of the direct waves and the magnitude of the indirect waves at a given point in time of a single sensor. Here, the magnitude of the direct wave or the magnitude of the indirect waves means a TOF of the direct wave or a TOF of the indirect waves or means the distance corresponding thereto.

A vehicle is equipped with multiple ultrasonic sensors, and although there may be no noise in output signals of a single ultrasonic sensor, there are cases in which this result of the single ultrasonic sensor contradicts the recognition results of other ultrasonic sensors.

Since the ultrasonic sensor is a sensor that measures the distance based on the time (TOF) between transmission and reception of the sound waves, there is a high probability that the distance to the closest object will be calculated. Therefore, in a multi-object situation where there are multiple objects around the vehicle, the closest object is likely to be detected.

However, depending on the situations, there is a possibility that the TOF may be updated by reflection from another distant object, and therefore there is a need to detect this TOF.

FIG. 5(a) illustrates a normal case, in which the reflection points according to the direct wave of the ultrasonic sensor (A) and the ultrasonic sensor (B) are obtained as M1 and M2, respectively, which are both points located on the wall, and the intersection (P) of the two direct waves is determined to be positions similar to M1 and M2.

On the other hand, FIG. 5(b) illustrates an abnormal case, that is, a case with diffuse reflection noise. As illustrated in the drawings, if the reflection point according to the direct wave of the ultrasonic sensor (A) is determined as (M′1), even if M′1 is a reflection point on the wall, the intersection of the direct wave of the ultrasonic sensor (A) and the direct wave of the ultrasonic sensor (B) is formed as ‘P’, and there is a significant error with respect to the distance to the actual object (reflection point).

Therefore, diffuse reflection noise should be detected, and if the diffuse reflection noise is relatively severe, it should not be used for object position estimation or reflection point determination.

Such diffuse reflection noise can be divided into two types of diffuse reflection noise.
Diffuse reflection noise of a single sensor
Diffuse reflection noise of multiple sensors

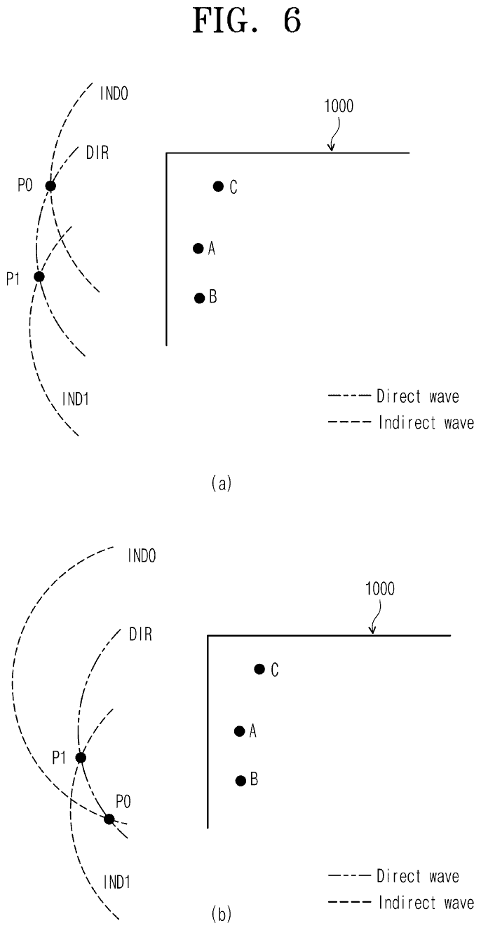

FIG. 6 is a diagram illustrating an example case in which diffuse reflection noise detection is required compared to another case (i.e., a normal case) in which diffuse reflection noise detection is not required.

FIG. 6 is a diagram illustrating diffuse reflection noise of a single sensor. The diffuse reflection noise of a single sensor, i.e., the diffuse reflection noise based on a single sensor, includes the diffuse reflection noise detected from the sensor data obtained based on the ultrasonic waves transmitted from one of the multiple ultrasonic sensors.

When the ultrasonic sensor (A) transmits ultrasonic waves, one direct wave and two indirect waves are updated. In FIG. 6, DIR represents the direct wave, and IND0 and IND1 represent the indirect waves.

As described above, the depicted direct wave or indirect waves may be a line or a region modeled as a semicircle or ellipse using the distance obtained from the sensor data (TOF) of the ultrasonic sensor, and it can be estimated that there is a reflection point (or object) on the circumference or perimeter of the semicircle and ellipse. In other words, the dotted line indicating the depicted direct wave or indirect waves may be considered to be the candidate reflection point or the position of a candidate object.

In FIG. 6, the intersection of the indirect wave (IND0) and the direct wave (DIR) traveling from the ultrasonic sensor (A) to the ultrasonic sensor (C) is referred to as P0, and the intersection of the indirect wave (IND1) and the direct wave (DIR) traveling from the ultrasonic sensor (A) to the ultrasonic sensor (B) is referred to as P1.

In a normal case without diffuse reflection noise, such as in FIG. 6(a), the relative positions or positional relationships of P0 and P1 (i.e., P1 is located below P1 based on the drawing) are identical, corresponding, coincident, or aligned with the relative positions or positional relationships of P0 and P1, the ultrasonic sensor (C) related to the indirect waves forming the P0 and P1 points, and the ultrasonic sensor (B) (i.e., ultrasonic the sensor (B) is located below the ultrasonic sensor (C) based on the drawing).

However, in a case with diffuse reflection noise, such as in FIG. 6(b), the relative positions of P0 and P1 (i.e., P1 is located above P0 based on the drawing) are reversed or inconsistent with, or do not coincide with, the relative positions of P0 and P1, the ultrasonic sensor (C) and the ultrasonic sensor (B) related to the indirect waves forming P0 and P1 (i.e., the ultrasonic sensor (B) is located below the ultrasonic sensor (C) based on the drawing). The reversal, change or difference in the relative positional relationship may be caused by diffuse reflection of ultrasonic waves, and the present disclosure proposes a method for detecting diffuse reflection noise.

In the present specification, the consistency of the relative positions or positional relationship can be determined based on whether the relative position or positional relationship has the same directionality. That is, if the relative position or positional relationship has the same directionality, it can be determined that there is consistency, or that they are identical, corresponding, matching, or matching each other. The directionality may be determined to be the direction of the vector connecting P0 to P1 on a plane (consisting of X and Y axes) and may be determined to be the direction of the vector interconnecting the ultrasonic sensor (B) and the ultrasonic sensor (C) on the same plane. If a difference in direction between the two vectors is within a preset range (angle), it can be determined that the two vectors have the same directionality.

In summary, the diffuse reflection noise based on a single sensor can be determined according to the following reference conditions (A) and (B).

The reference condition (A) indicates the relative positions or positional relationships of two intersections of direct and indirect waves obtained by using ultrasonic waves output from any one of a plurality of ultrasonic sensors, and the relative positions or positional relationships of two ultrasonic sensors receiving the indirect waves or related to the indirect waves.

The reference condition (B) indicates the relationship between the distance between the two intersections and the average distance between the plurality of ultrasonic sensors.

The reference conditions (A) and (B) can be simultaneously considered and used to determine diffuse reflection noise based on a single sensor. In some cases, only the reference condition (A) may be used to determine diffuse reflection noise based on a single sensor. 14

In more detail, in a situation where both the reference conditions (A) and (B) are considered, if the relative positional relationship of two intersections of direct and indirect waves obtained using ultrasonic waves transmitted from any one of the multiple ultrasonic sensors and the relative positional relationship of two ultrasonic sensors related to the indirect waves do not correspond to each other, and if the distance (i.e., P̅0̅P̅1̅ in FIG. 6) between the two intersections is longer than the average distance between the multiple ultrasonic sensors (i.e., (A̅B̅+A̅C̅)/2 in FIG. 6), it can be determined that there is a single sensor-based diffuse reflection noise in the obtained sensor data. In this case, the obtained sensor data can be ignored or removed. In other words, the obtained sensor data is not used to estimate the position of the object (or obstacle).

Meanwhile, in a situation where the relative positional relationship of two intersections corresponds to the relative positional relationship of two ultrasonic sensors related to the indirect waves, if the distance between the two intersections is less than the average distance between multiple ultrasonic sensors, this means occurrence of a relatively small diffuse reflection phenomenon, i.e., this means that there is no diffuse reflection noise to be removed, and the obtained sensor data may be used to estimate the position of the object (or obstacle).

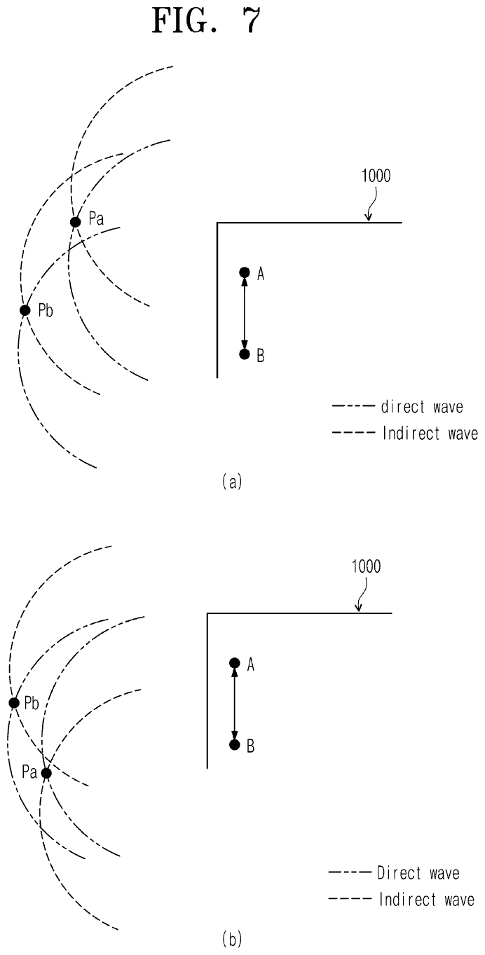

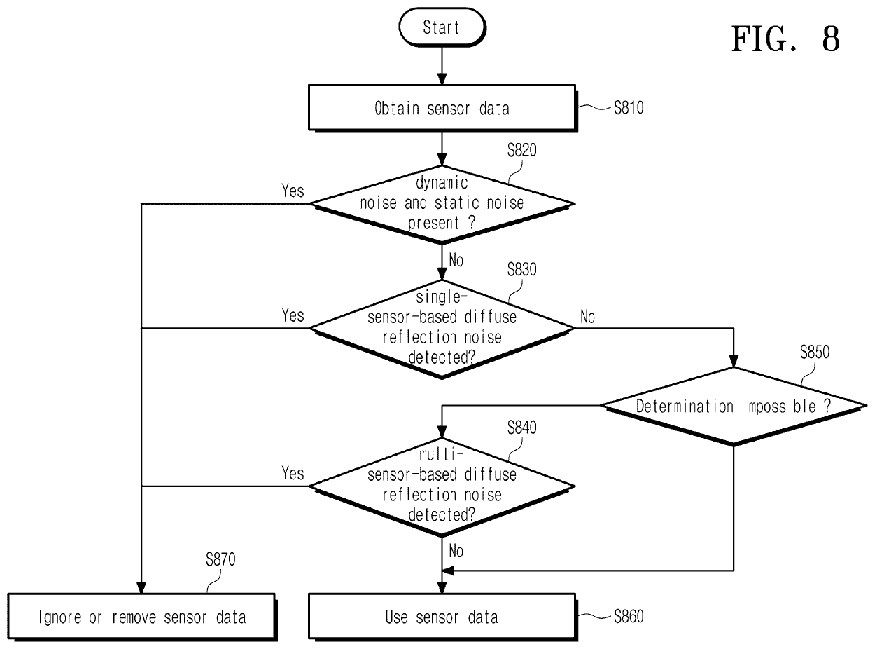

FIG. 7 is a diagram illustrating an example case in which diffuse reflection noise detection is required compared to another case (i.e., a normal case) in which diffuse reflection noise detection is not required.

FIG. 7 is a diagram for explaining diffuse reflection noise of multiple sensors. Diffuse reflection noise of the multiple sensors, i.e., diffuse reflection noise based on the multiple sensors, includes diffuse reflection noise detected from sensor data obtained based on ultrasonic waves transmitted from two sensors from among a plurality of ultrasonic sensors.

In FIG. 7, the intersection of the direct wave obtained from the ultrasonic sensor (A) transmitting ultrasonic waves and the indirect wave obtained from the ultrasonic sensor (B) is referred to as ‘Pa’, and the intersection of the direct wave obtained from the ultrasonic sensor (B) transmitting ultrasonic waves and the indirect wave obtained from the ultrasonic sensor (A) is referred to as ‘Pb’.

Similar to the case of the diffuse reflection noise based on a single sensor, the diffuse reflection noise based on multiple sensors can be determined based on the relative positional relationship of the two intersections (Pa, Pb) and the relative positional relationship of the ultrasonic sensor (A) and the ultrasonic sensor (B) related to the two intersections or the direct or indirect wave forming the two intersections.

In a normal case without diffuse reflection noise such as FIG. 7(a), the relative positional relationship of ‘Pa’ and ‘Pb’ (i.e., ‘Pb’ is located below ‘Pa’ based on the drawing) is identical to, coincides with, or matches the relative positional relationship of the ultrasonic sensor (A) and the ultrasonic sensor (B) related to ‘Pa’, ‘Pb’, or the direct wave forming ‘Pa’ and ‘Pb’ (i.e., the ultrasonic sensor (B) is located below the ultrasonic sensor (A) based on the drawing).

However, in another case with diffuse reflection noise such as in FIG. 7(b), the relative positional relationship between ‘Pa’ and ‘Pb’ (i.e., ‘Pb’ is located above ‘Pa’ based on the drawing) is reversed or inconsistent with, or not aligned with, the relative positional relationship between the ultrasonic sensor (A) and the ultrasonic sensor (B) related to ‘Pa’ and ‘Pb’, or the direct wave forming ‘Pa’ and ‘Pb’ (i.e., the ultrasonic sensor (B) is located below the ultrasonic sensor (A) based on the drawing). This reversal, change, or difference in the relative positional relationship may be caused by diffuse reflection of ultrasonic waves.

In summary, the diffuse reflection noise based on the multiple sensors can be determined according to the following reference conditions (A) and (B).

The reference condition (A) indicates the relative position or positional relationship of the intersection of the direct wave obtained based on the ultrasonic waves transmitted from the first sensor among the two ultrasonic sensors and the indirect wave obtained from the second sensor, and the intersection of the direct wave obtained based on the ultrasonic wave transmitted from the second sensor and the indirect wave obtained from the first sensor, and the relative position or positional relationship of the first sensor and the second sensor.

The reference condition (B) indicates the relationship between the distance between the two intersections and the average distance between the multiple ultrasonic sensors.

The reference conditions (A) and (B) may be used to determine the diffuse reflection noise based on multiple sensors. In some cases, only the reference condition (A) may be used to determine the diffuse reflection noise based on the multiple sensors.

More specifically, conditions (A) and (B) can be used as follows.

If the relative positional relationship between the intersection (Pa) of the direct wave received from the sensor (A) and the indirect wave received from the sensor (B), wherein the direct and indirect waves of the intersection (Pa) are obtained based on the ultrasonic waves transmitted from the sensor (A) from among the two sensors and the intersection (Pb) of the direct wave received from the sensor (B) and the indirect wave received from the sensor (A), wherein the direct and indirect waves of the intersection (Pb) are obtained based on the ultrasonic waves received from the sensor (B), does not correspond to the relative positional relationship between the sensor (A) and the sensor (B), and if the distance (P̅a̅P̅b̅ in FIG. 6) between the two intersections is longer than half (A̅B̅/2) of the distance between the sensor (A) and the sensor (B), this means that diffuse reflection noise based on multiple sensors occurs in the obtained sensor data. In this case, the obtained sensor data can be ignored or removed. In other words, the obtained sensor data is not used to estimate the position of an object (or obstacle).

Meanwhile, in a situation where the relative positional relationship of two intersections corresponds to the relative positional relationship of two ultrasonic sensors related to the indirect waves, if the distance between the two intersections is smaller half the distance between the sensors associated with the two intersections, this means occurrence of a relatively small diffuse reflection phenomenon, i.e., this means that there is no diffuse reflection noise to be removed, and the obtained sensor data may be used to estimate the position of the object (or obstacle).

On the other hand, half of the distance between the sensors (A, B) compared to the distance between the two intersections is only an example, and a reference distance determined based on the distance between the sensors (A, B) may be used as a reference for comparison.

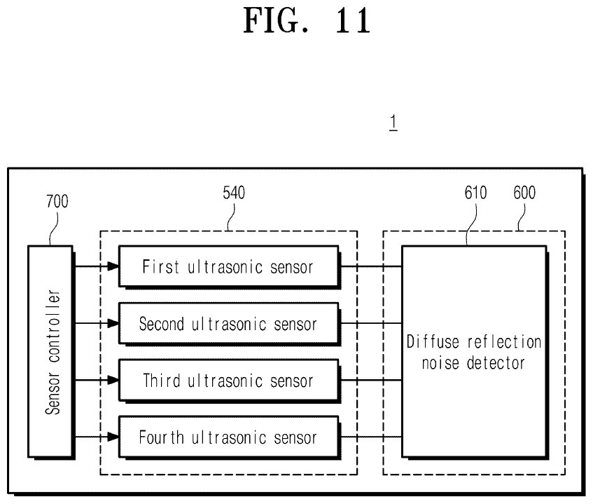

FIG. 8 is a flowchart illustrating a method for detecting diffuse reflection noise according to the embodiments of the present disclosure. The method of FIG. 8 can be performed by an apparatus 1 for detecting diffuse reflection noise (hereinafter referred to as diffuse reflection noise detection device 1). The diffuse reflection noise detection device 1 will be described later with reference to FIG. 11. Hereinafter, the method will be briefly described as being performed by the device 1.

The device 1 may obtain ultrasonic sensor data (S810). The ultrasonic sensor data includes TOF measured from a plurality of ultrasonic sensors. The device 1 may obtain direct waves of each ultrasonic sensor based on ultrasonic sensor data, and may obtain indirect waves based on ultrasonic waves received from each ultrasonic sensor.

The device 1 may determine whether dynamic noise or static noise exists in the obtained sensor data (S820). Determination of dynamic noise or static noise is omitted in the present specification. Meanwhile, depending on the embodiment, S820 may not be included in the diffuse reflection noise detection method. If there is dynamic noise or static noise in the obtained sensor data, the device 1 can ignore or remove the obtained sensor data (S870). In addition, the device 1 can return to S810 to receive new ultrasonic sensor data.

The device 1 may determine whether diffuse reflection noise based on a single sensor has occurred in the obtained sensor data (S830). If the single sensor-based diffuse reflection noise is present in the obtained sensor data, the device 1 can ignore or remove the obtained sensor data (S870). Thereafter, the device 1 can return to S810 to receive new ultrasonic sensor data.

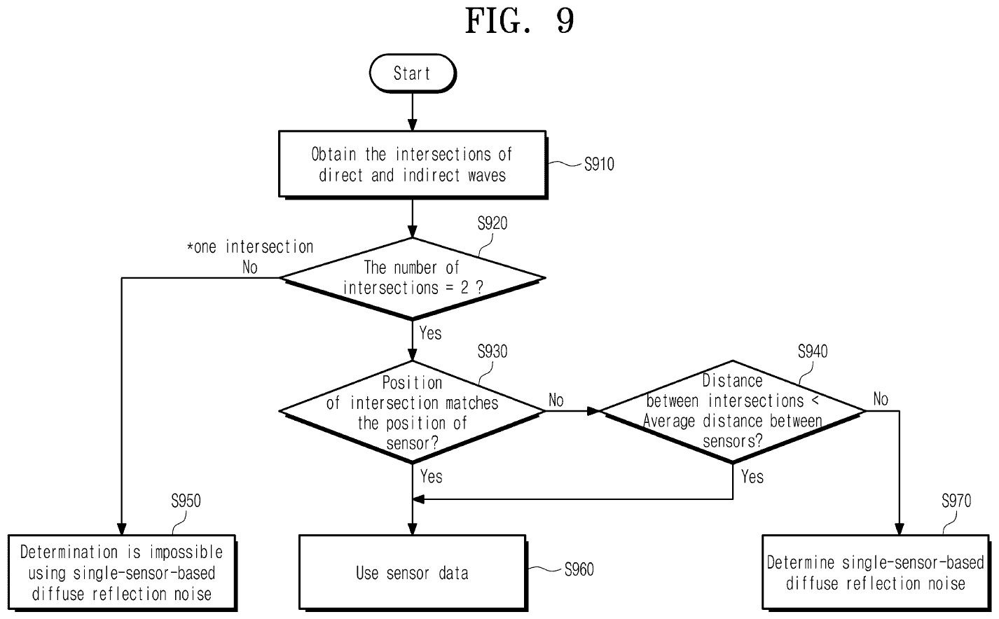

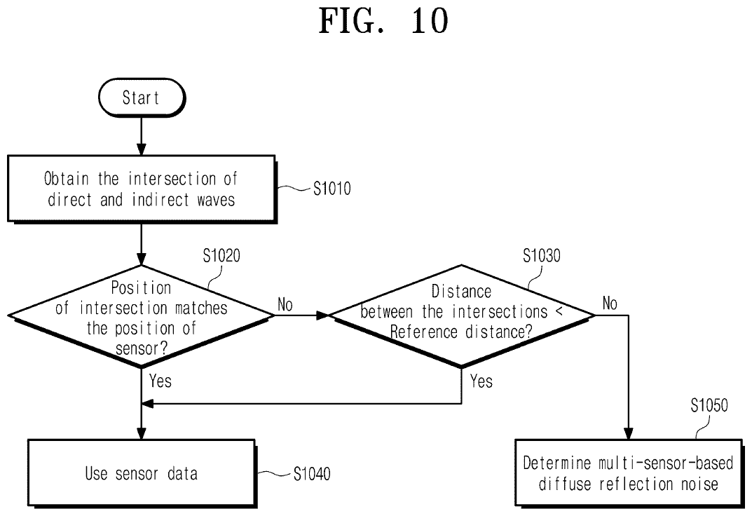

A method for determining occurrence or non-occurrence of diffuse reflection noise based on the single sensor will be described later with reference to FIG. 9. In addition, the determination of occurrence or non-occurrence of the single-sensor-based diffuse reflection noise will be described with reference to FIG. 6 and a detailed description of FIG. 6.

If occurrence of the single-sensor-based diffuse reflection noise in the obtained sensor data is not determined, the device 1 may determine whether it is not possible to determine the single-sensor-based diffuse reflection noise based on the obtained sensor data (S850).

If it is determined that the single-sensor-based diffuse reflection noise is not present based on the obtained sensor data, the device 1 may use the obtained sensor data to estimate the position of an object (or obstacle) (S860).

If it is determined that the device 1 is unable to determine the single-sensor-based diffuse reflection noise based on the obtained sensor data, the device 1 may determine whether the obtained sensor data contains diffuse reflection noise based on multiple sensors (S840). If the obtained sensor data contains diffuse reflection noise based on multiple sensors, the device 1 can ignore or remove the obtained sensor data (S870). Thereafter, the device 1 can return to S810 to receive new ultrasonic sensor data.

Determination of diffuse reflection noise based on multiple sensors will be described later with reference to FIG. 10. In addition, the determination of diffuse reflection noise based on multiple sensors will be described later with reference to FIG. 7 and a detailed description of FIG. 7.

FIG. 9 is a flowchart illustrating a method for detecting diffuse reflection noise according to the embodiments of the present disclosure. The method of FIG. 9 can be performed by the device 1 for detecting diffuse reflection noise. The diffuse reflection noise detection device 1 will be described later with reference to FIG. 11. Hereinafter, the method will be briefly described as being performed by the device 1.

More specifically, FIG. 9 shows a method for determining diffuse reflection noise based on the single sensor.

The device 1 may obtain the intersection of the direct wave and the indirect wave obtained by using the ultrasonic waves received from one of the plurality of ultrasonic sensors based on the obtained sensor data (S910). If the procedure of FIG. 9 is performed as part of FIG. 8 (e.g., S830), the intersection information of the direct wave and the indirect wave may be obtained in advance. In this case, S910 may be omitted.

The device 1 may determine whether the number of intersections of the direct wave and the indirect wave obtained for one transmitted (Tx) ultrasonic wave (or ultrasonic waves obtained from one transmitted (Tx) ultrasonic sensor) is set to 2 (S920).

In a normal state, one direct wave and two indirect waves can be obtained based on one transmitted (Tx) ultrasonic wave, and accordingly, the device 1 can obtain the intersection of the direct wave and the first indirect wave and the other intersection of the direct wave and the second indirect wave.

However, in an abnormal state, the number of intersections of the obtained direct wave and indirect wave may be set to 1. If the number of intersections of the obtained direct wave and indirect wave is 1, the device 1 may determine that it is impossible to determine whether the obtained sensor data contains diffuse reflection noise based on single sensor-based data (S950). In this case, S840 of FIG. 8 may be initiated. This will be described later with reference to FIG. 10.

If the number of intersections of the obtained direct wave and indirect wave is 2, the device 1 may determine whether the relative positions or positional relationships of the two intersections correspond to or coincide with the relative positions or positional relationships of the two sensors associated with the indirect waves forming the two intersections (S930). The relative positions or positional relationships of the two intersections and the relative positions or positional relationships of the two sensors associated with the indirect waves forming the two intersections will be described with reference to FIG. 6 and a detailed description of FIG. 6.

If the relative positions or positional relationships of the two intersections correspond to or coincide with the relative positions or positional relationships of the two sensors associated with the indirect waves forming the two intersections, the device 1 may use the obtained sensor data to estimate the position of the object (or obstacle) (S960).

If the relative positions or positional relationships of the two intersections do not correspond to or coincide with the relative positions or positional relationships of the two sensors associated with the indirect waves forming the two intersections, the device 1 can compare the distance between the two intersections with the average distance between the plurality of ultrasonic sensors (S940).

If the distance between the two intersections is less than the average distance between the plurality of ultrasonic sensors, the device I can use the obtained sensor data to estimate the position of the object (or obstacle) (S960).

If the distance between two intersections is greater than the average distance between multiple ultrasonic sensors, the device 1 may determine that the single-sensor-based diffuse reflection noise has occurred in the obtained sensor data (S970). The device 1 can ignore or remove the obtained sensor data.

The content described with reference to FIGS. 2 to 8, which are not described with reference to FIG. 9, can also be applied to the method for determining single-sensor-based diffuse reflection noise according to FIG. 9.

FIG. 10 is a flowchart illustrating a method for detecting diffuse reflection noise according to the embodiments of the present disclosure. The method of FIG. 10 can be performed by the device 1 for detecting diffuse reflection noise. The diffuse reflection noise detection device I will be described later with reference to FIG. 11. Hereinafter, the method will be briefly described as being performed by the device 1.

More specifically, FIG. 10 shows a method for determining diffuse reflection noise based on multiple sensors.

The device I can obtain the intersection of the direct wave and the indirect wave obtained by using ultrasonic waves received from one of the plurality of ultrasonic sensors based on the obtained sensor data (S1010). When the procedure of FIG. 10 is performed as part of FIG. 8 (e.g., S840), the intersection information of the direct wave and the indirect wave may be obtained in advance. In this case, S1010 may be omitted.

In the method of FIG. 10, the intersection of the direct wave and the indirect wave may include the intersection of the direct wave and the indirect wave obtained from the second sensor (which are obtained based on an ultrasonic wave transmitted from the first sensor from among two ultrasonic sensors among the plurality of ultrasonic sensors), and may include the intersection of the direct wave and the indirect wave obtained from the first sensor (which are obtained based on an ultrasonic wave transmitted from the second sensor).

The device 1 may determine whether the relative positions or positional relationships of two intersections correspond to or coincide with the relative positions or positional relationships of two sensors associated with the direct wave forming the two intersections (S1020).

When the relative positions or positional relationships of the two intersections correspond to or coincide with the relative positions or positional relationships of the two ultrasonic sensors associated with the direct wave forming the two intersections, the device 1 may use the obtained sensor data to estimate the position of the object (or obstacle) (S1040).

When the relative positions or positional relationships of the two intersections do not correspond to or coincide with the relative positions or positional relationships of the two sensors associated with the indirect waves forming the two intersections, the device 1 may compare the distance between the two intersections with a reference distance determined based on the distance between the two ultrasonic sensors associated with the direct wave forming the two intersections (S1030).

When the distance between the two intersections is less than the reference distance, the device 1 can use the obtained sensor data to estimate the position of the object (or obstacle) (S1040).

When the distance between the two intersections is longer than the reference distance, the device 1 may determine that diffuse reflection noise based on the multiple sensors is included in the obtained sensor data (S1050). At this time, the device 1 can ignore or remove the obtained sensor data.

The content described with reference to FIGS. 2 to 8, which are not described with reference to FIG. 10, can also be applied to the method for determining multiple-sensor-based diffuse reflection noise according to FIG. 10.

FIG. 11 is a block diagram illustrating the device for detecting diffuse reflection noise in sensor data according to the embodiments of the present disclosure.

The diffuse reflection noise detection device 1 may include a controller 600 configured to perform diffuse reflection noise detection, an ultrasonic sensor 540, and a sensor controller 700.

The sensor controller 700 may control the ultrasonic sensor 540. The sensor controller 700 may adjust or tune the characteristics of ultrasonic waves received from the ultrasonic sensor 540. In addition, the sensor controller 700 may control a time point at which ultrasonic waves from the ultrasonic sensor 540 are output.

The controller 600 may include a diffuse reflection noise detector 610.

The diffuse reflection noise detector 610 may obtain sensor data from the ultrasonic sensor 540.

The diffuse reflection noise detector 610 may attempt to detect the single-sensor-based diffuse reflection noise from the obtained sensor data. If detection of the single-sensor-based diffuse reflection noise is not successful, the diffuse reflection noise detector 610 may be configured to detect the diffuse reflection noise based on multiple sensors.

The single-sensor-based diffuse reflection noise may include diffuse reflection noise detected from sensor data obtained based on ultrasonic waves transmitted from one of the plurality of ultrasonic sensors 540, and the multi-sensor-based diffuse reflection noise may include diffuse reflection noise detected from sensor data obtained based on ultrasonic waves transmitted from two of the plurality of ultrasonic sensors 540.

The diffuse reflection noise detector 610 may be configured to detect the single-sensor-based diffuse reflection noise not only based on the relative positional relationship of the intersection of the direct wave and the two indirect waves (which are obtained using a transmission (Tx) ultrasonic wave of any one of the plurality of ultrasonic sensors), but also based on the relative positional relationship of the two ultrasonic sensors that detect (or form) the indirect waves or is related to the indirect waves.

The diffuse reflection noise detector 610 may additionally be configured to detect the single-sensor-based diffuse reflection noise not only based on the distance between the two intersections but also based on the average distance between the plurality of ultrasonic sensors 540.

When the relative positional relationship of two intersections of direct and indirect waves obtained using ultrasonic waves transmitted from one of the plurality of ultrasonic sensors 540 and the relative positional relationship of two ultrasonic sensors that detect (or form) the indirect waves or are related to the indirect waves do not correspond to each other and the distance between the two intersections is longer than the average distance between the plurality of ultrasonic sensors, the diffuse reflection noise detector 610 may determine that single-sensor-based diffuse reflection noise is included in the obtained sensor data.

The diffuse reflection noise detector 610 may detect multi-sensor-based diffuse reflection noise not only based on the relative positional relationship between the intersection (Pa) of the direct wave received from the first sensor and the indirect wave received from the second sensor, which are obtained based on an ultrasonic wave transmitted from the first sensor from 22 among two ultrasonic sensors of the plurality of ultrasonic sensors 540 and the intersection (Pb) of the direct wave received from the second sensor and the indirect wave received from the first sensor, which are obtained based on an ultrasonic wave transmitted from the second sensor. The diffuse reflection noise detector 610 may additionally be configured to detect the multi-sensor-based diffuse reflection noise based on the reference distance. Here, the reference distance may be determined according to the distance determined based on the distance between the first sensor and the second sensor.

When the relative positional relationship of the intersection (Pa) of the direct wave received from the first sensor and the indirect wave received from the second sensor, which are obtained based on an ultrasonic wave transmitted from the first sensor from among two ultrasonic sensor, and the intersection (Pb) of the direct wave received from the second sensor and the indirect wave received from the first sensor, which are obtained based on an ultrasonic wave transmitted from the second sensor does not correspond to the relative positional relationship between the first sensor and the second sensor, and when the distance between two intersections (Pa, Pb) is longer than the reference distance determined based on the distance between the first sensor and the second sensor, the diffuse reflection noise detector 610 may determine that multi-sensor-based diffuse reflection noise has occurred in the obtained sensor data.

The diffuse reflection noise detector 610 may be configured to ignore or remove the obtained sensor data when single-sensor-based diffuse reflection noise or multi-sensor-based diffuse reflection noise is detected.

For content related to the device 1 not described with reference to FIG. 11, reference may be made to the descriptions related to FIGS. 3 to 10, and the content thereof may be applied to the device 1 of FIG. 11.

Meanwhile, as another embodiment of the present disclosure, a vehicle 1000 including the above-described device 1 is proposed.

Although the above-described embodiments of the present disclosure have disclosed that the device (or system) for preventing collision in rear-end parking of a vehicle, and components included the device or system perform such control for convenience of description, the device (or system) and the components belonging thereto are names only and the scope of rights is not dependent thereon.

In other words, the proposed technology of the present disclosure may be performed by devices having names other than the processor, controller, etc. In addition, the method, scheme, or the like described above may be performed by software or code readable by a computer or other machine or device for vehicle control.

In addition, as another aspect of the present disclosure, the operation of the proposed technology described above may be provided as code that may be implemented, realized, or executed by a “computer” (a generic concept including a system on chip (SoC) or a (micro) processor) or a computer-readable storage medium, a computer program product, or the like storing or containing the code. The scope of the present disclosure is extendable to the code or the computer-readable storage medium or the computer program product storing or containing the code.

Detailed descriptions of preferred embodiments of the present disclosure disclosed as described above have been provided such that those skilled in the art may implement and realize the present disclosure.

Although the present disclosure has been described above with reference to preferred embodiments, those skilled in the art will understand that various modifications and changes can be made to the present disclosure set forth in the claims below.

Accordingly, the present disclosure is not intended to be limited to the embodiments shown herein but is to be accorded the widest scope consistent with the principles and novel features disclosed herein.

As is apparent from the above description, the method and apparatus according to the embodiments of the present disclosure have the following effects.

The embodiments of the present disclosure can detect diffuse reflection noise in ultrasonic sensor data.

In addition, the embodiments of the present disclosure can ignore or remove sensor data from which diffuse reflection noise is detected, thereby preventing the false braking phenomenon due to false recognition of an obstacle.

It will be apparent to those skilled in the art that various modifications and variations can be made in the present disclosure without departing from the spirit or scope of the disclosures. Thus, it is intended that the present disclosure covers the modifications and variations of this disclosure provided they come within the scope of the appended claims and their equivalents.

What is claimed is:

1. An apparatus for detecting diffuse reflection noise with respect to ultrasonic sensor values comprising:
a plurality of ultrasonic sensors; and
a processor including a diffuse reflection noise detector configured to detect diffuse reflection noise in sensor values obtained from the ultrasonic sensors,
wherein the diffuse reflection noise detector is configured to:
detect single-sensor-based diffuse reflection noise in obtained sensor data; and
in response to not detecting the single-sensor-based diffuse reflection noise, detect multi-sensor-based diffuse reflection noise.

2. The apparatus according to claim 1, wherein:
the single-sensor-based diffuse reflection noise includes diffuse reflection noise detected from sensor data obtained based on an ultrasonic wave which is transmitted by any one of the plurality of ultrasonic sensors; and
the multi-sensor-based diffuse reflection noise includes diffuse reflection noise detected from sensor data obtained based on ultrasonic waves which are transmitted by two ultrasonic sensors among the plurality of ultrasonic sensors.

3. The apparatus according to claim 2, wherein the diffuse reflection noise detector is configured to:
detect the single-sensor-based diffuse reflection noise based on a relative positional relationship of intersections of a direct wave and two indirect waves obtained using an ultrasonic wave which are transmitted by any one ultrasonic sensor from among the plurality of ultrasonic sensors, and a relative positional relationship of two ultrasonic sensors related to the indirect waves.

4. The apparatus according to claim 3, wherein the diffuse reflection noise detector is further configured to:
detect the single-sensor-based diffuse reflection noise based on a distance between the two intersections and an average distance between the plurality of ultrasonic sensors.

5. The apparatus according to claim 2, wherein the diffuse reflection noise detector is configured to:
determine that the single-sensor-based diffuse reflection noise is included in the obtained sensor data, when a relative positional relationship of two intersections of direct and indirect waves obtained using the ultrasonic wave transmitted from any one of the plurality of ultrasonic sensors does not correspond to a relative positional relationship of two ultrasonic sensors related to the indirect waves, and when a distance between the two intersections is longer than an average distance between the plurality of ultrasonic sensors,.

6. The apparatus according to claim 2, wherein the diffuse reflection noise detector is configured to:
detect the multi-sensor-based diffuse reflection noise based on a relative positional relationship between an intersection (Pa) of a direct wave received from a first sensor of the two ultrasonic sensors and an indirect wave received from a second sensor of the two ultrasonic sensors, wherein the direct and indirect waves of the intersection (Pa) are obtained based on an ultrasonic wave transmitted from the first sensor, and another intersection (Pb) of a direct wave received from the second sensor and an indirect wave received from the first sensor, wherein the direct and indirect waves of the intersection (Pb) are obtained based on an ultrasonic wave transmitted from the second sensor, and a relative positional relationship between the first sensor and the second sensor.

7. The apparatus according to claim 6, wherein the diffuse reflection noise detector is further configured to:
detect the multi-sensor-based diffuse reflection noise based on a reference distance that is determined based on a distance between the two intersections and a distance between the first sensor and the second sensor.

8. The apparatus according to claim 2, wherein the diffuse reflection noise detector is configured to:
determine that the multi-sensor-based diffuse reflection noise is included in the obtained sensor data, when a relative positional relationship between an intersection (Pa) of a direct wave received from a first sensor of the two ultrasonic sensors and an indirect wave received from a second sensor of the two ultrasonic sensors, wherein the direct and indirect waves of the intersection (Pa) are obtained based on an ultrasonic wave transmitted from the first sensor, and another intersection (Pb) of a direct wave received from the second sensor and an indirect wave received from the first sensor, wherein the direct and indirect waves of the intersection (Pb) are obtained based on an ultrasonic wave transmitted from the second sensor, does not correspond to a relative positional relationship between the first sensor and the second sensor, and when a distance between the two intersections is longer than a reference distance determined based on the distance between the first sensor and the second sensor.

9. The apparatus according to claim 1, wherein the diffuse reflection noise detector is configured to:
ignore or remove the obtained sensor data when the single-sensor-based diffuse reflection noise or the multi-sensor-based diffuse reflection noise is detected.

10. A vehicle including an apparatus for detecting diffuse reflection noise according to claims 1.

11. A method for detecting diffuse reflection noise with respect to ultrasonic sensor values by a diffuse reflection noise device that includes a plurality of ultrasonic sensors and a processor including a diffuse reflection noise detector configured to detect diffuse reflection noise in sensor values obtained from the ultrasonic sensors, the method comprising:
attempting to detect single-sensor-based diffuse reflection noise in obtained sensor data; and
attempting to detect multi-sensor-based diffuse reflection noise when the single-sensor-based diffuse reflection noise is not detected.

12. The method according to claim 11, wherein:
the single-sensor-based diffuse reflection noise includes diffuse reflection noise detected from sensor data obtained based on an ultrasonic wave which are transmitted by any one of the plurality of ultrasonic sensors; and
the multi-sensor-based diffuse reflection noise includes diffuse reflection noise detected from sensor data obtained based on ultrasonic waves which are transmitted by two ultrasonic sensors among the plurality of ultrasonic sensors.

13. The method according to claim 11, further comprising:
ignoring or removing the obtained sensor data when the single-sensor-based diffuse reflection noise or the multi-sensor-based diffuse reflection noise is detected.

14. A vehicle including an apparatus for detecting diffuse reflection noise according to claim 2.

15. A vehicle including an apparatus for detecting diffuse reflection noise according to claim 3.

16. A vehicle including an apparatus for detecting diffuse reflection noise according to claim 4.

17. A vehicle including an apparatus for detecting diffuse reflection noise according to claim 5.

18. A vehicle including an apparatus for detecting diffuse reflection noise according to claim 6.

19. A vehicle including an apparatus for detecting diffuse reflection noise according to claim 7.

20. A vehicle including an apparatus for detecting diffuse reflection noise according to claim 8.
